(19) United States
(12) Patent Application Publication
(10) Pub. No.: US 2008/0107253 A1
(43) Pub. Date: May 8, 2008

(54) METHODS AND SYSTEMS FOR SPEED DIAL

(75) Inventor: Arun Gupta, Faridabad (IN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INDIA TECHNOLOGY PVT. LTD., Noida (U.P.) (IN)

(21) Appl. No.: 11/876,025

(22) Filed: Oct. 22, 2007

(30) Foreign Application Priority Data
Nov. 7, 2006 (IN) 2424/DEL/2006

(51) Int. Cl. H04M 3/42

(52) U.S. Cl. 379/216.01

(57) ABSTRACT

An embodiment of a method of speed dial performed in an electronic apparatus comprising a keypad comprising multiple buttons and a display unit is provided. The method comprises the following steps. A numeric sequence is displayed on the display unit for further edit when detecting that a button on the keypad is pressed over a predetermined time period. The numeric sequence is a portion of a full phone number.

### CROSS REFERENCE TO RELATED APPLICATIONS

This application claims benefit of India Provisional Patent Application Ser. No. 2424/DEL/2006, filed 7 Nov. 2006. The contents of the provisional applications are hereby incorporated by reference.

### BACKGROUND

The invention relates to a telecommunication device, and in particular to methods and systems capable of speed dial.

Some telecommunication devices have a feature (referred to herein as “speed dial”) that allows a user to store one or more telephone numbers in a storage device and then initiate a telephone call using one of the pre-stored telephone numbers through a relatively simple process. For example, speed dial may be performed by pressing a button programmed with a pre-stored telephone number. Accordingly, there is a need for systems and methods that enables flexible speed dial.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

An embodiment of a method of speed dial performed in an electronic apparatus comprising a keypad comprising multiple buttons and a display unit is provided. The method comprises the following steps. A numeric sequence is displayed on the display unit for further edit when detecting that a button on the keypad is pressed over a predetermined time period. The numeric sequence is a portion of a full phone number.

Also provided is an embodiment of a method of speed dial configuration. The method comprises the following steps. A numeric sequence is provided. A flag corresponding to the numeric sequence, indicating the numeric sequence is a first full phone number or a portion of a second full phone number, is provided. Information regarding a speed dial button on a keypad for the numeric sequence is provided. The numeric sequence with the provided flag and information regarding the speed dial button is stored in a storage unit.

Also provided is an embodiment of a system of speed dial comprising a keypad comprising a button, a display unit and a processor. The processor displays a numeric sequence on the display unit for further edit when detecting that the button on the keypad is pressed over a predetermined time period. The numeric sequence is a portion of a full phone number.

### BRIEF DESCRIPTION OF DRAWINGS

The invention can be more fully understood by reading the subsequent detailed description and examples with references made to the accompanying drawings, wherein:

FIG. 1 is a schematic view of an embodiment of a system;

FIG. 2 is a flowchart illustrating an embodiment of a method of speed dial configuration;

FIG. 3 is a diagram of an exemplary data table storing information regarding two sets of speed dial numeric sequences;

FIG. 4 is a flowchart illustrating an embodiment of a method of speed dial;

FIG. 5 is a diagram of an embodiment of a mobile phone comprising a keypad placing several buttons;

FIG. 6a is a diagram illustrating an exemplary screen displaying a partial phone number; and

FIG. 6b is a diagram illustrating an exemplary screen displaying a complete phone number containing a displayed partial phone number followed by another numeric sequence.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constrains, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

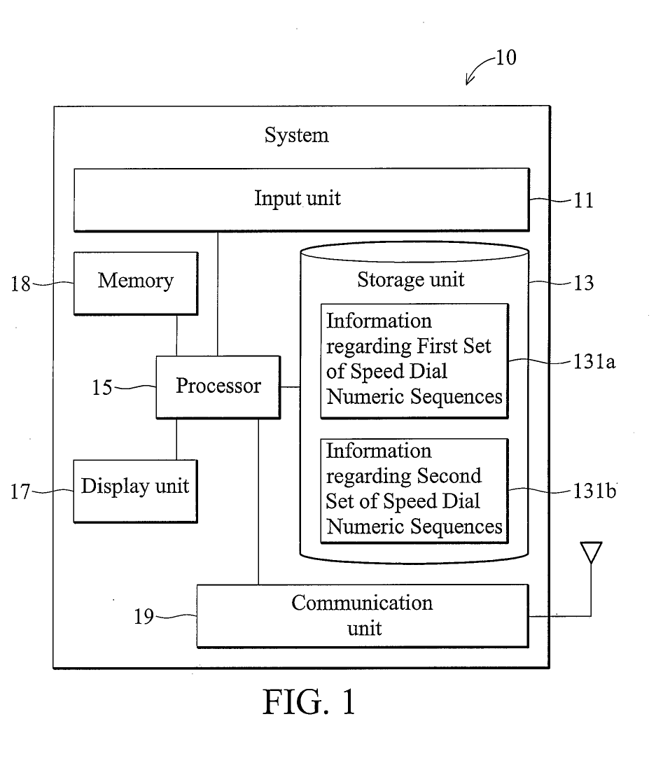

FIG. 1 is a schematic view of an embodiment of a system 10 implementing speed dial, comprising an input unit 11, storage unit 13, processor 15, a display unit 17, memory 18, and a communication unit 19.

The input unit 11 may comprise a keypad controller, and a keypad placing a plurality of buttons. The processor 15 may receive signals via the keypad controller 11 when one button is pressed.

The storage unit 13 is a non-volatile storage device, such as a SIM (subscriber identity module) card, flash memory, external memory card (e.g. SD, SM card, or memory stick), or others. The storage unit 13 stores information regarding two sets of speed dial numeric sequences 131a and 131b. It is to be understood that the storage unit 13 storing information regarding more than two sets of speed dial numeric sequences is also available. Each speed dial numeric sequence is associated with a full phone number flag and one button on the keypad. The associated button is considered as a speed dial button. The full phone number flag is utilized to indicate that the corresponding speed dial numeric sequence represents a partial phone number or a full phone number. The full phone number identifies a telephone, a mobile phone, a smart phone, or the similar, such as an extension number, a telephone number, a mobile phone number, or others. The partial phone number is a portion of numeric sequence of one or more phone numbers.

The processor 15 selects a particular set of speed dial numeric sequences in response to a press frequency indicating that a switching button has been pressed over a predetermined time period, retrieves a corresponding speed dial numeric sequence from the selected set with reference to the stored information regarding the selected set (e.g. 131a or 131b) after receiving a signal indicating that a particular speed dial button has been pressed over a predetermined time period (also referred to as long press). The switching button is a button preserved to switch to a particular speed dial sets, may be labeled by “*”, “#”, or others. The speed dial button is a button preserved to activate speed dial, may be labeled by numbers such as one of “1” to “9”. The processor 15 further directs the communication unit 19 to initiate a telephone call to a destination identified by the retrieved speed dial numeric sequence when the retrieved one represents a full phone number, and directs the display unit 17 to display the retrieve speed dial numeric sequence for further edit by an user when the retrieved one is a partial phone number.

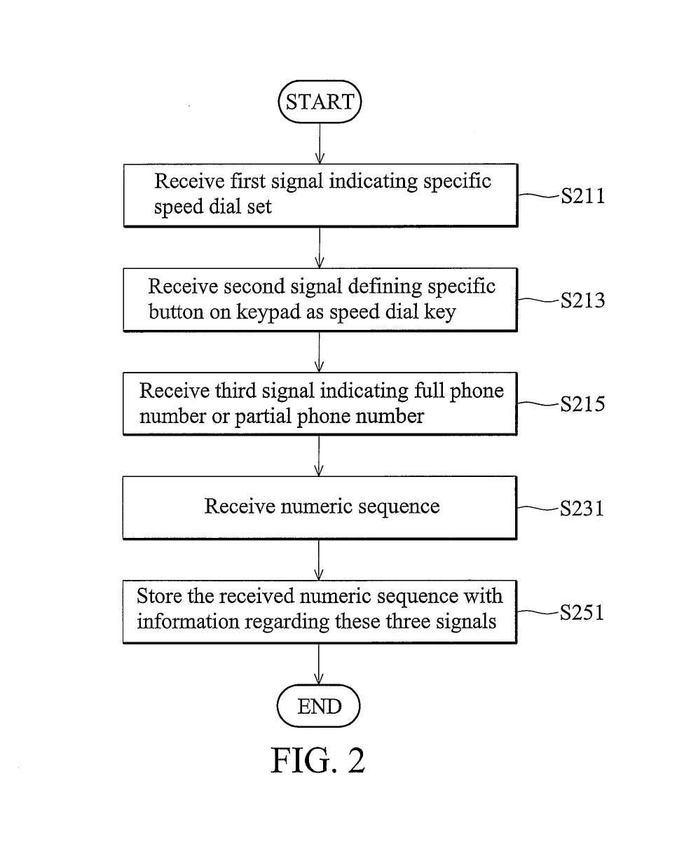

FIG. 2 is a flowchart illustrating an embodiment of a method of speed dial configuration to generate and store information regarding a single speed dial numeric sequence (e.g. 131a and 131b). Those skilled in the art may practice the flowchart in a loop to configure multiple speed dial numeric sequences. The method of FIG. 2 can be employed by the processor 15 of FIG. 1. First signal indicating a specific speed dial set is/are received (step S211). The first signal may contain a number, an alphanumeric character, or the combination identifying a specific speed dial set, and may be generated according to a user input. Second signal defining a specific button on a keypad as a speed dial key is received (step S213). Third signal indicating a full phone number or a partial phone number is received (step S215). A numeric sequence such as “1886”, “8901”, or others, is received (step S231). A man-machine interface (MMI) may be provided to facilitate user input of these three signals and the numeric sequence with proper prompts. Note that the order of steps S211 to S231 can be modified to apply to various embodiments. The received numeric sequence with information regarding these three signals is stored in a storage device (e.g. 13 of FIG. 1) (step S251).

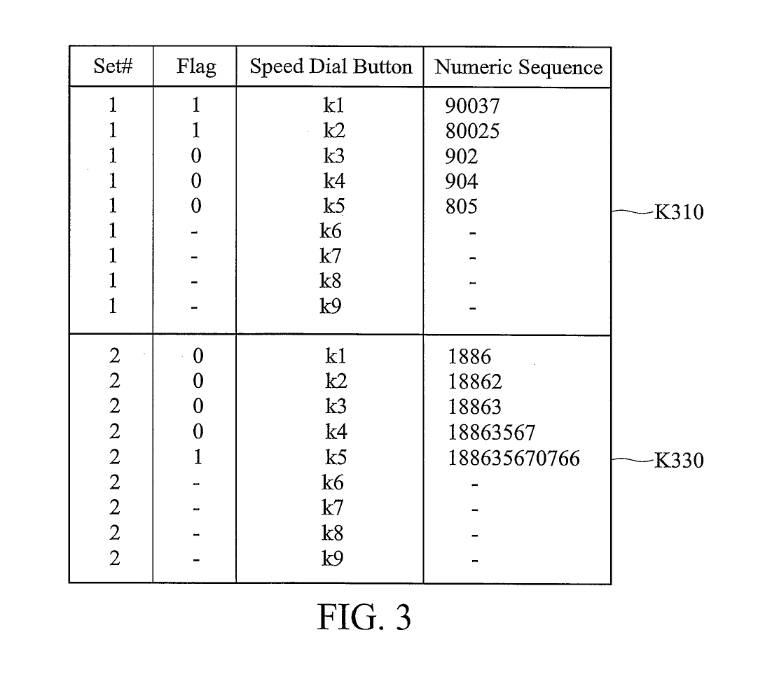

FIG. 3 is a diagram of an exemplary data table storing information regarding two sets of speed dial numeric sequences K310 and K330. Each set is labeled by a number illustrated in a “Set#” column. Each numeric sequence illustrated in a “Numeric Sequence” column is associated with a full phone number flag and a speed dial button respectively illustrated in “Flag” and “Speed Dial Button” columns. The full phone number flag of one indicates that a corresponding numeric sequence represents a full phone number. The full phone number flag of zero indicates that a corresponding numeric sequence represents a partial phone number. “K1” to “K9” of the speed dial column are identifiers of buttons on a keypad. For example, “K1” refers to a button labeled by “1”, “K2” refers to a button labeled by “2”, and so on. Those skilled in the art may practice the data table in various data structures such as data array, linked list, data objects, or the combination.

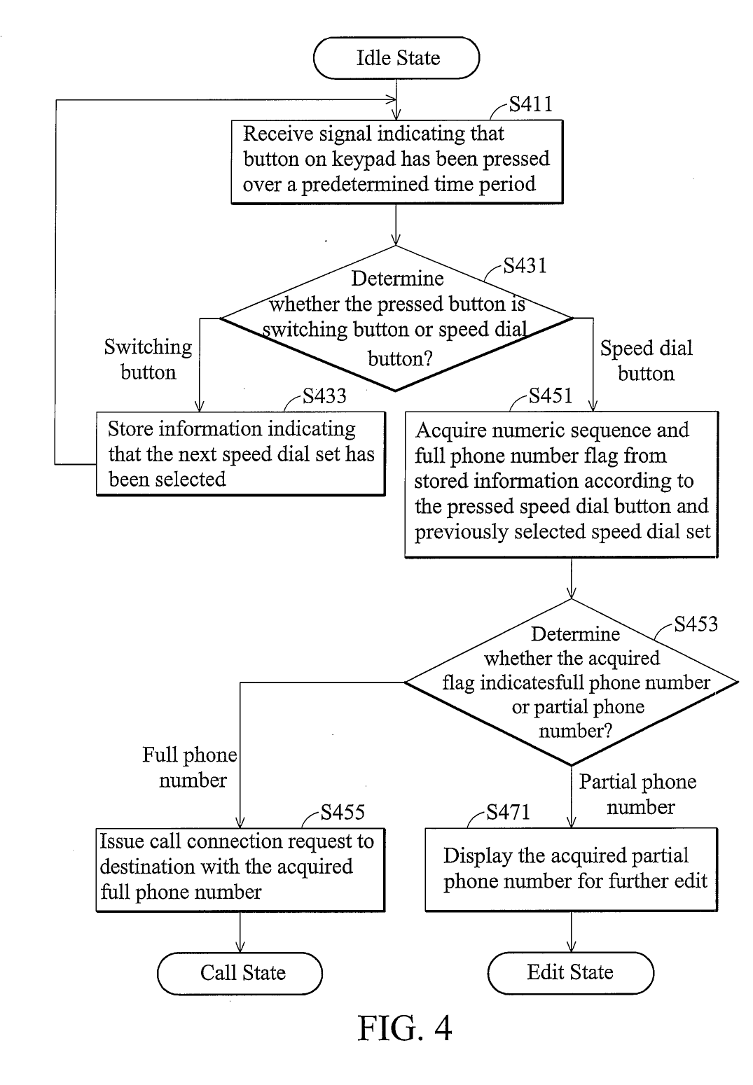

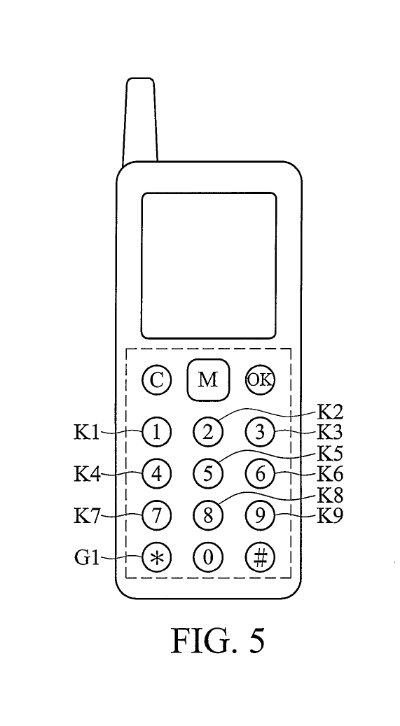

FIG. 4 is a flowchart illustrating an embodiment of a method of speed dial. The method of FIG. 4 can be employed by the processor 15 of FIG. 1. The process is initiated in an idle state. When entering the idle state, an idle screen is displayed, and the entire system may enter a power save mode (PSM). Signal indicating that a button on a keypad has been pressed over a predetermined time period is received (step S411). It is determined whether the pressed button is a switching button or a speed dial button (step S431). FIG. 5 is a diagram of an embodiment of a mobile phone comprising a keypad placing several buttons. Wherein, a button labeled by “*” G1 is defined as the switching button, and buttons labeled by “1” to “9” K1 to K9 are defined as the speed dial buttons.

Referring to FIG. 3, Information indicating that the next speed dial set has been selected is stored when the switching button has been pressed over a predetermined time period (step S433). It is to be understood that such information may be stored with a variable, flag, or the similar in memory (e.g. 18 of FIG. 1). A numeric sequence and a full phone number flag are acquired from the stored information (e.g. FIG. 3) according to the pressed speed dial button and previously selected speed dial set. For example, referring to FIGS. 3 and 5, when the first speed dial set K310 has been selected, a speed dial button K1 is pressed over a predetermined time period, a numeric sequence “90037” and the associated full phone number flag of one are acquired with reference to the stored information (FIG. 4). After acquiring the numeric sequence and the associated full phone number flag (step S451), it is determined whether the acquired flag indicates a full phone number or a partial phone number (step S453). For example, the acquired flag of one indicates a full phone number, otherwise, indicates a partial phone number.

A call connection request is issued to a telephone, a mobile phone or a smart phone with the acquired full phone number to establish a call connection with the desired destination when the acquired flag indicates a full phone number (step S455), and then, a call state is entered. It is to be understood that, when the call connection request is acknowledged, the entire system communicates with the destination via a telephony network, an IP (Internet Protocol) network, a cellular network such as global system for mobile communications (GSM), general packet radio service (GPRS), enhanced data rates for global evolution (EDGE), code division multiple access (CDMA), wideband code division multiple access (WCDMA), or the similar. When the call connection request is rejected, the entire system may enter the idle state again.

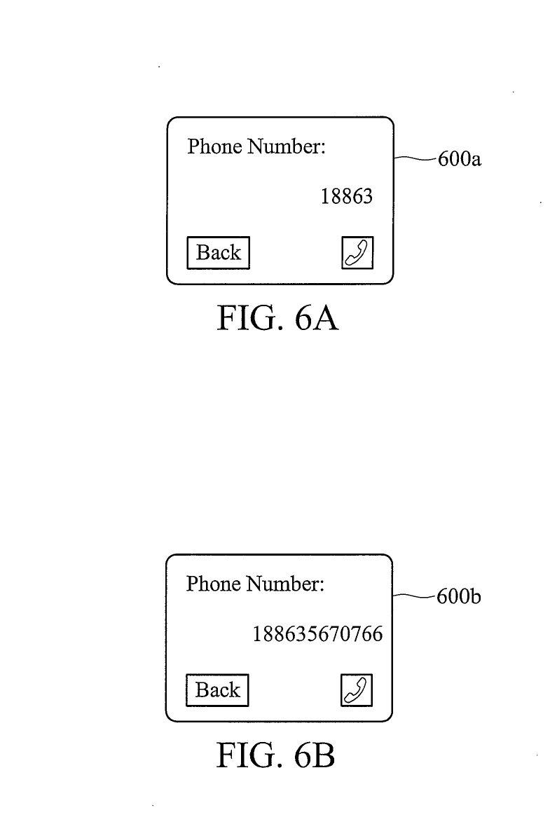

The acquired numeric sequence is displayed on a display unit (e.g. 17 of FIG. 1) for further edit by a user when the acquired flag indicates a partial phone number (step S471), and then, an edit state is entered. FIG. 6a is a diagram illustrating an exemplary screen displaying a partial phone number when the second speed dial set has been selected and the button K3 is pressed over a predetermined time period. It is to be understood that, when entering an edit state, the displayed numeric sequence can be edited to complete a full phone number for subsequent dialing. A portion of the displayed numeric sequence may be deleted or replaced with difference numbers, or another numeric sequence may be appended to the displayed numeric sequence. FIG. 6b is a diagram illustrating an exemplary screen displaying a complete phone number containing the displayed partial phone number as shown in FIG. 6a, followed by another numeric sequence “5670766” input by a user.

Methods for speed dial, or certain aspects or portions thereof, may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a mobile phone or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, such as a computer, a mobile phone or similar, the machine becomes an apparatus for practicing the invention. When implemented on a general-purpose processor, the program codes combine with the processor to provide a unique apparatus that operate analogously to specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but function.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of speed dial performed in an electronic apparatus comprising a keypad comprising a plurality of buttons and a display unit, the method comprising:
displaying a first numeric sequence on the display unit for further edit when detecting that a first button on the keypad is pressed over a predetermined time period,
wherein the first numeric sequence is a portion of a first full phone number.

2. The method of claim 1, further comprising:
generating the full phone number by modifying the first numeric sequence; and
issuing a call connection request to a destination with the first full phone number to establish a call connection with the destination.

3. The method of claim 1, wherein the destination is a telephone, a mobile phone or a smart phone.

4. The method of claim 1, further comprising issuing a call connection request to a destination with a second numeric sequence when detecting that a second button is pressed over a predetermined time period.

5. The method of claim 4, further comprising:
acquiring information indicating that the second button is associated with the second numeric sequence and a flag for the second numeric sequence; and
issuing the call connection request to the destination after determining that the flag indicates that the second numeric sequence is a full phone number.

6. The method of claim 1, further comprising:
acquiring information indicating that the first button is associated with the first numeric sequence and a flag for the first numeric sequence; and
displaying the first numeric sequence one the display unit after determining that the flag indicates that the first numeric sequence is a partial phone number.

7. The method of claim 1, further comprising:
determining a speed dial set when detecting that a second button on the keypad is pressed over a predetermined time period; and
retrieving the first numeric sequence from the determined speed dial set before displaying the first numeric sequence.

8. The method of claim 7, further comprising:
switching to the next speed dial set when detecting that the second button on the keypad is pressed over a predetermined time period;
retrieving a second numeric sequence from the newly determined speed dial set when detecting the first button is pressed over a predetermined time period.

9. The method of claim 8, further comprising:
issuing the call connection request to a destination with the retrieved second numeric sequence after determining the second numeric sequence is a full phone number; and
displaying the second numeric sequence on the display unit for further edit after determining the second numeric sequence is a portion of a full phone number.

10. A method of speed dial configuration, comprising:
providing a numeric sequence;
providing a flag corresponding to the numeric sequence, indicating the numeric sequence is a first full phone number or a portion of a second full phone number;
providing information regarding a speed dial button on a keypad for the numeric sequence; and
storing the numeric sequence with the provided flag and information regarding the speed dial button in a storage unit.

11. The method of claim 10, further comprising:
retrieving the stored numeric sequence and the flag when detecting that the speed dial button is pressed over a time period;
determining whether the retrieved flag indicates the numeric sequence is the first full phone number or a portion of the second full phone number; and
displaying the retrieved numeric sequence on a display unit for further edit when determining that the retrieved numeric sequence is a portion of the second full phone number.

12. The method of claim 11, further comprising issuing a call connection request to a destination with the retrieved numeric sequence when determining that the retrieved numeric sequence is the first full phone number.

13. The method of claim 10, further comprising:
providing an identity indicating a speed dial set; and
storing the numeric sequence further with the provided identity.

14. The method of claim 13, further comprising:
determining that the speed dial set is switched to after detecting that a switching button is pressed over a predetermined time period;
retrieving the stored numeric sequence and the flag after detecting that the speed dial button is pressed over a time period and the speed dial set is switched to;
determining whether the retrieved flag indicates the numeric sequence is the first full phone number or a portion of the second full phone number; and
displaying the retrieved numeric sequence on a display unit for further edit when determining that the retrieved numeric sequence is a portion of the second full phone number.

15. A system of speed dial, comprising:
a keypad, comprising a first button;
a display unit; and
a processor, displaying a first numeric sequence on the display unit for further edit when detecting that the first button on the keypad is pressed over a predetermined time period,
wherein the first numeric sequence is a portion of a first full phone number.

16. The system of claim 15, further comprising a communication unit, wherein the processor generates the full phone number by modifying the first numeric sequence, and issues a call connection request to a destination with the first full phone number via the communication unit to establish a call connection with the destination.

17. The system of claim 15, further comprising a communication unit, wherein the keypad further comprises a second button, and the processor issues a call connection request to a destination with a second numeric sequence via the communication unit when detecting that a second button is pressed over a predetermined time period.

18. The system of claim 15, wherein the keypad comprises a second button, and the processor determines a speed dial set when detecting that the second button is pressed over a predetermined time period, and retrieves the first numeric sequence from the determined speed dial set before displaying the first numeric sequence.

19. The system of claim 18, wherein the processor further switches to the next speed dial set when detecting that the second button on the keypad is pressed over a predetermined time period, and retrieves a second numeric sequence from the newly determined speed dial set when detecting the first button is pressed over a predetermined time period.

20. The system of claim 19, further comprising a communication unit, wherein the processor further issues the call connection request to a destination with the retrieved second numeric sequence after determining the second numeric sequence is a full phone number, and displays the second numeric sequence on the display unit for further edit after determining the second numeric sequence is a portion of a full phone number.
